(19) United States
(12) Patent Application Publication
(10) Pub. No.: US 2020/0226120 A1
(43) Pub. Date: Jul. 16, 2020

(54) REMOTE DEVICE MANAGEMENT

(71) Applicant: Arm IP Limited, Cambridge (GB)

(72) Inventors: Daniel Ros, Sawston (GB); Gary Thomson, March (GB); Robert George Taylor, Cambridge (GB)

(21) Appl. No.: 16/736,386

(22) Filed: Jan. 7, 2020

(30) Foreign Application Priority Data
Jan. 11, 2019 (GB) GB 1900427.4

(51) Int. Cl. G06F 16/23; G06F 16/22; G06F 16/93; G16Y 40/35

(52) U.S. Cl. CPC G06F 16/2358; G16Y 40/35; G06F 16/93; G06F 16/2272

(57) ABSTRACT

An apparatus comprising a document store to store an index of remote device data, the remote device data being aggregated in a structured state document, conforming to a document schema, from a plurality of data sources for each of a plurality of remote devices. The apparatus comprises an outbound delta processor to transmit a desired state to a remote device when the desired state does not match a last reported state of the remote device defined in the structured state document for that remote device. Also the apparatus comprises and an inbound notification processor to receive a current state of the remote device to update the last reported state of the remote device in the structured state document.

### RELATED APPLICATION

The present application claims priority to Application No. GB 1900427.4 filed Jan. 11, 2019, which is hereby incorporated herein in its entirety by reference.

The present techniques relate to methods and apparatus for remote device management. More particularly, the techniques relate to methods and apparatus for remote device management using indexed data.

Cloud computing services are becoming more common. More and more devices are being connected to the cloud, for example as part of the “Internet of Things” (IoT). For example, devices such as temperature sensors, healthcare monitors and electronic door locks can be connected to the cloud so that they can be accessed and controlled using remote systems. For example, a door may be remotely opened from a remote platform, or data from a temperature sensor or healthcare monitor may be aggregated at a remote location and accessed from another device. Hence, there is an increasing amount of data being collected by cloud platforms and their providers.

Device management platforms allow an operator to make decisions for remote devices, for example by determining which devices to target device management thereof. This however requires significant operator input. It would therefore be desirable to provide an alternative system.

According to a first aspect of the present technique, there is provided an apparatus comprising: a document store to store an index of remote device data, the remote device data being aggregated in a structured state document, conforming to a document schema, from a plurality of data sources for each of a plurality of remote devices; an outbound delta processor to transmit a desired state to a remote device when the desired state does not match a last reported state of the remote device defined in the structured state document for that remote device; and an inbound notification processor to receive a current state of the remote device to update the last reported state of the remote device in the structured state document.

According to a second aspect of the present technique, there is provided a method comprising receiving a user input at an application programming interface (API), the user input comprising a state change request document defining a desired state of one or more of a plurality of remote devices; identifying, from an index of remote device data, which of the plurality of remote devices has a last reported state which is not equal to the desired state; and transmitting instructions to each of the identified remote devices, to change a current state of each of the identified remote devices to the desired state.

According to a third aspect of the present technique, there is provided a method comprising receiving, at an inbound notification processor, a current state of a remote device from the remote device; determining if a structured state document for the remote device requires updating; if the structured state document for the remote device is determined to require updating, validating the update of the structured state document at a document processor.

According to a fourth aspect of the present technique, there is provided an apparatus comprising a document store to store an index of remote device data, the remote device data being aggregated in a structured state document, conforming to a document schema, from a plurality of data sources for each of a plurality of remote devices; and an application programming interface to receive user input, the user input being a query of the index of remote device data.

According to a fifth aspect of the present technique, there is provided a method comprising receiving a user input at an application programming interface, the user input being a query of an index of remote device data; and in response, receiving data for one or more of a plurality of remote devices from the index of remote device data, the index being an index of structured state documents conforming to a document schema, the structured state documents comprising data from a plurality of data sources for each of the plurality of remote devices.

Embodiments will now be described with reference to the accompanying figures of which:

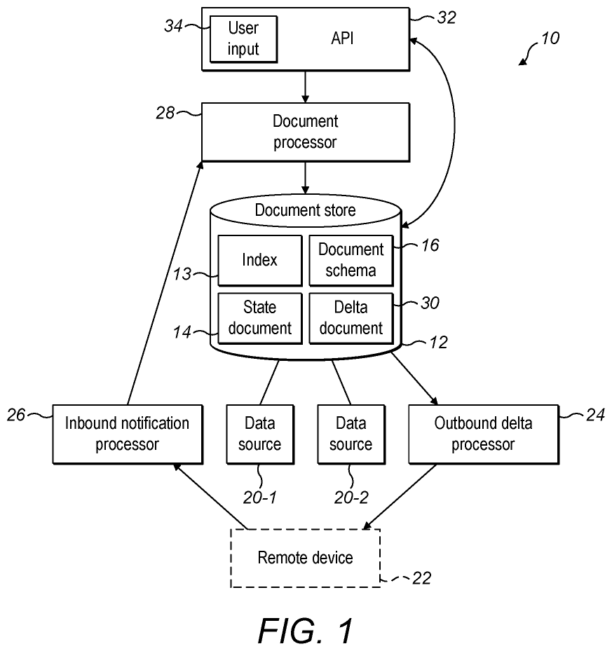

FIG. 1 illustrates a schematic diagram of an apparatus according to various examples;

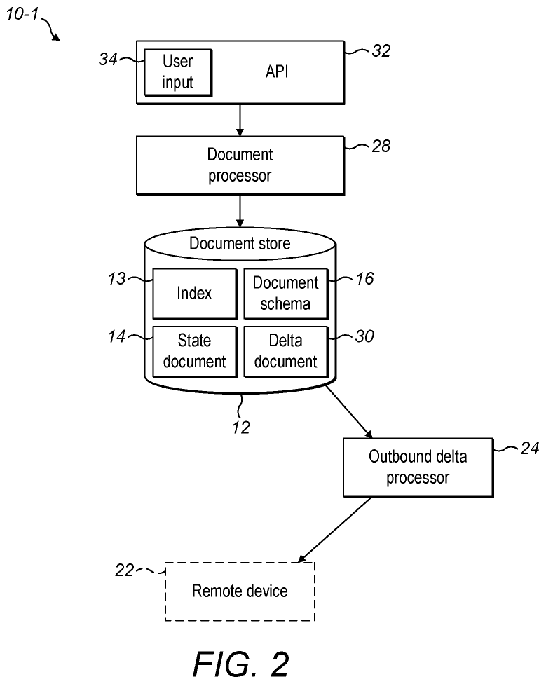

FIG. 2 illustrates a schematic diagram of an apparatus according to various examples;

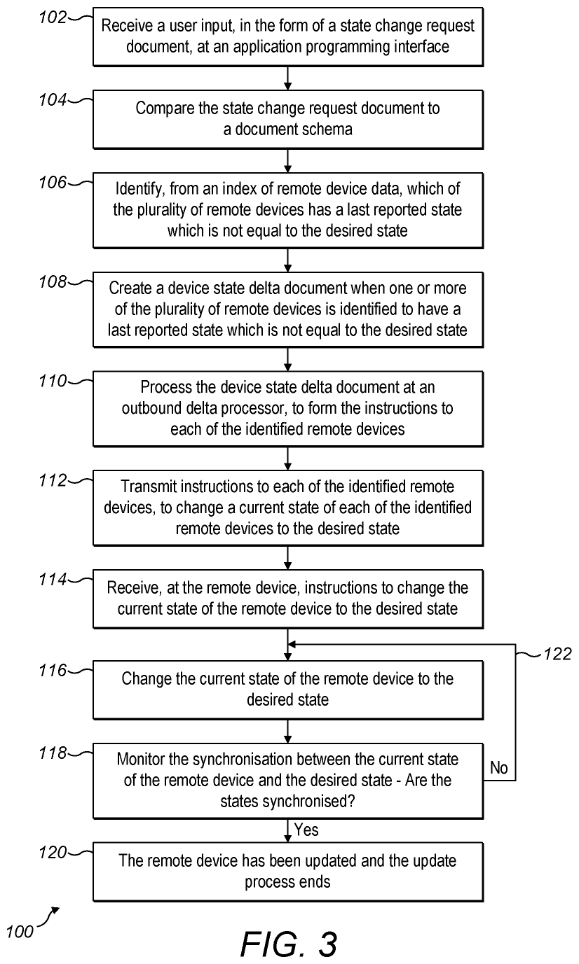

FIG. 3 illustrates a flow diagram of blocks of a method according to various examples;

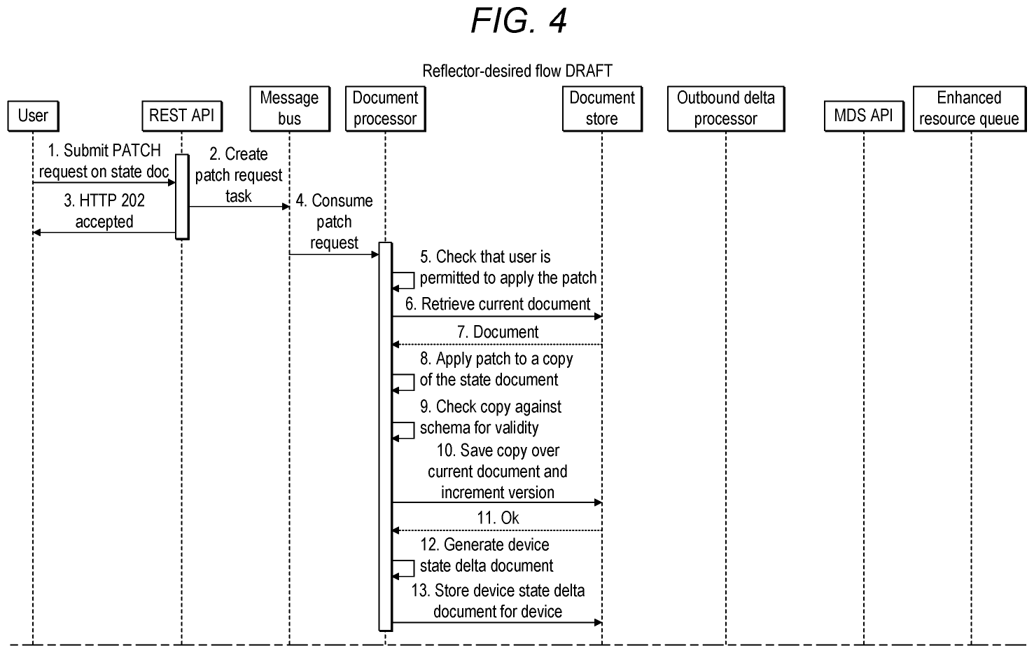

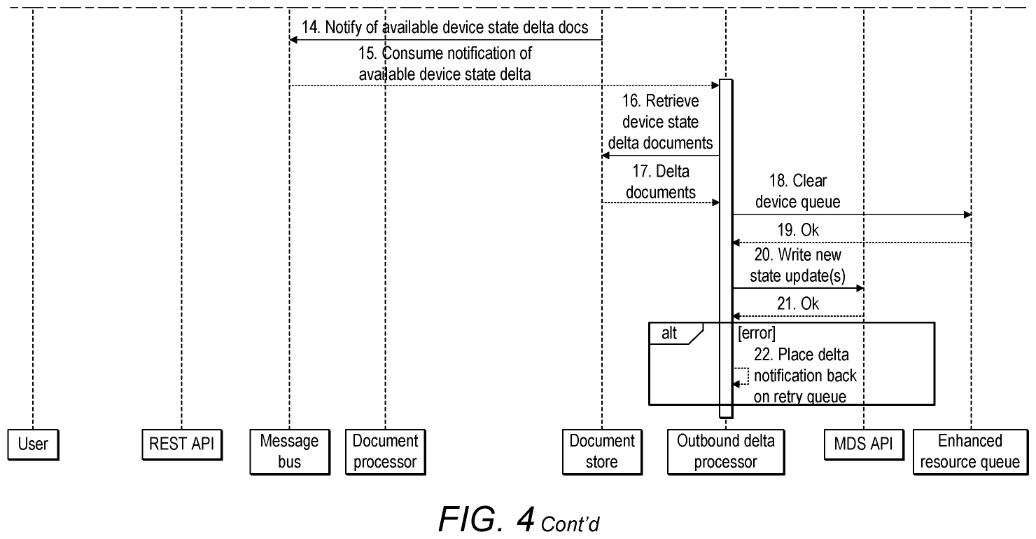

FIG. 4 illustrates a sequence diagram illustrating a method according to various examples.

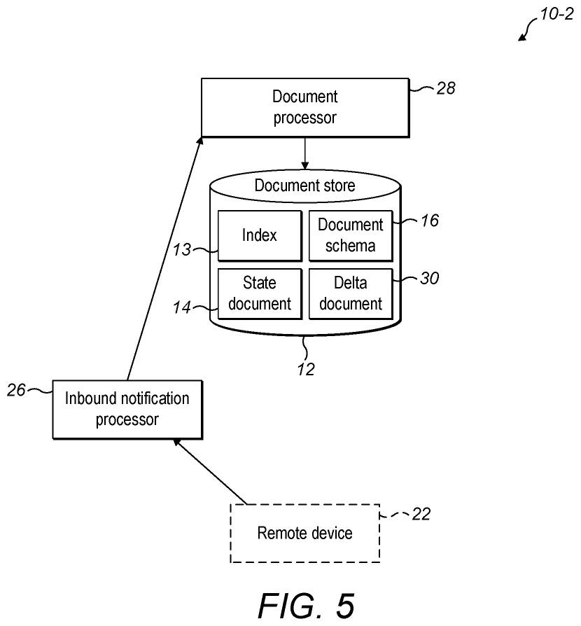

FIG. 5 illustrates a schematic diagram of an apparatus according to various examples;

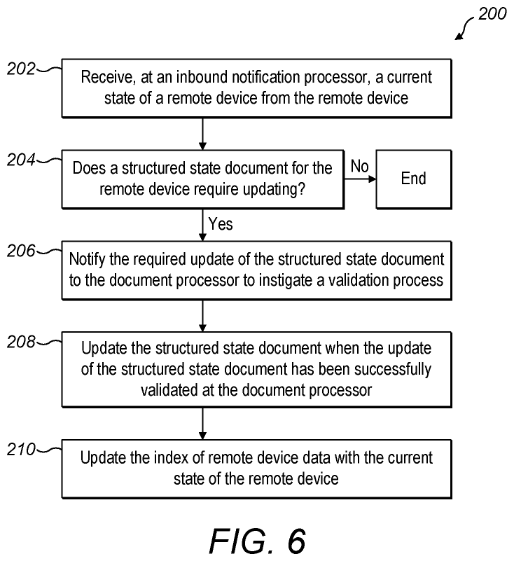

FIG. 6 illustrates a flow diagram of blocks of a method according to various examples;

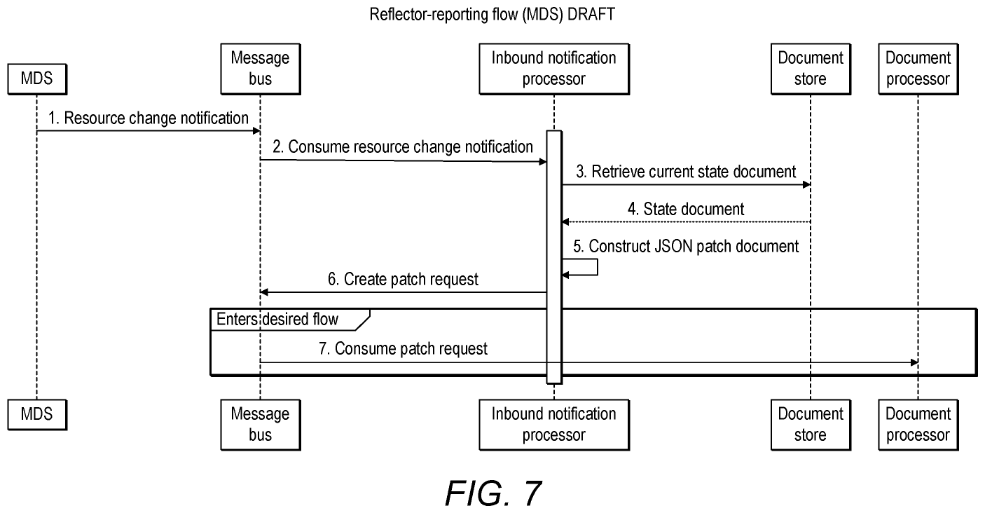

FIG. 7 illustrates a sequence diagram illustrating a method according to various examples.

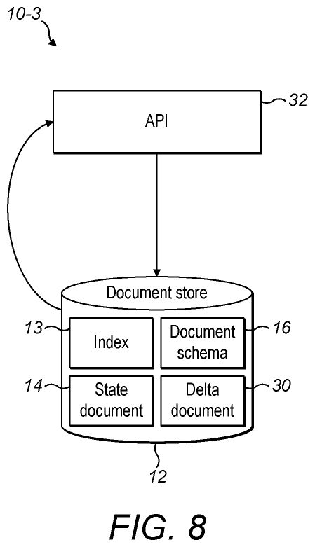

FIG. 8 illustrates a schematic diagram of an apparatus according to various examples; and

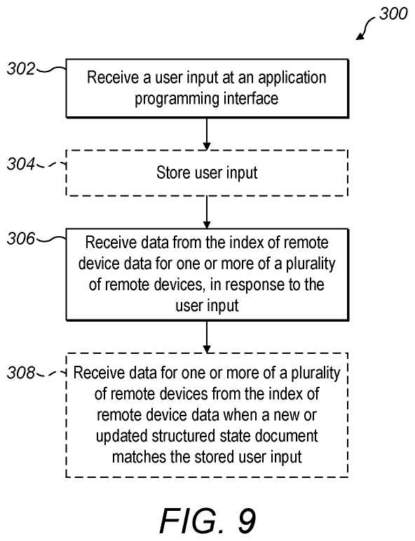

FIG. 9 illustrates a flow diagram of blocks of a method according to various examples.

FIG. 1 illustrates a schematic diagram of an apparatus 10 comprising a document store 12 to store an index 13 of remote device data, the remote device data being aggregated in a structured state document 14, conforming to a document schema 16, for each of a plurality of remote devices 22. The structured state document 14 for each of the plurality of remote devices 22 is aggregated from one or more data sources 20, for example two data sources 20-1, 20-2. The structured state document 14 may be considered to be a reflection of a remote device 22. The remote devices 22 also provide data for the structured state document 14. The structured state document 14 may comprise a plurality of elements. The structured state document 14 is the primary way that device data is stored, viewed and manipulated. An example structured state document is shown below.

{

“document_schema”: 1,
“variables”: {

“example_device_variable”: {

“reported_value”: “0”,
“desired_value”: “1”,
“reported_ts”: “2016-11-30T16:25:12.1234Z”,
“desired_ts”: “2016-11-30T16:25:12.1234Z”,
“status”: “RESOLVING”

}

},
“$metadata”: {

“document_version”: 1,
“device_updated_ts”: “2016-11-30T16:25:12.1234Z”,
“api_updated_ts”: “2016-11-30T16:25:12.1234Z”,
“status”: “RESOLVING”

}

}

The document schema 16 may be specific to a remote device 22 or remote device type. The document schema 16 and the structured state document 14 for a remote device 22 may be stored in the document store 12. The document schema 16 dictates the structure of the structured state document 14 and all of its elements. The document schema 16 may be derived from a device's matching model in a device catalogue.

The document store 12 may be a cloud based system such that structured state documents 14 for a plurality of remote devices 22 and the searchable index 13 are always available in the cloud. Such a cloud based system may also be called a reflection or reflector. The structured state documents 14 comprise a copy of the last reported values of any variables for the remote devices 22.

The structured state document 14 may receive incoming data from the various coupled or coupleable data sources 20-1, 20-2, and/or the remote devices 22 continuously, intermittently, periodically or a combination thereof. For example one data source 20-1 may provide streaming data whilst a second data source 20-2 provides data every hour. Different data sources 20-1, 20-2, may provide data in different timescales and via different communication methods. The data from the various data sources 20-1, 20-2 may be cross referenced as necessary.

The structured state document 14 may be updated in part from various data sources, for example by a patch operation using, for example, the JSONPatch standard. JSONPatch is a format which describes changes to a document where only part of the document has changed, such that the JSON patch operation can be used to apply changes to the document without having to change the whole document, thereby saving data bandwidth. A standard format for constructing patches, for example a JSONPatch, allows re-use of existing libraries for the application programming interface (API). The use of a standard format for constructing patches makes it easier for users to understand what is going on as patch documents are in a standard format. The structured state document 14 may comprise a list of resources and last reported values. The structured state document 14 may comprise a list of attributes and their values.

The structured state document 14 may also comprise metadata relating to the source and age of each element of data, which may subsequently be used as a data filtering field in any search of the data elements or index thereof. The metadata in the structured state document 14 is not user modifiable.

The plurality of data sources 20-1, 20-2, may for example be cloud services from which data can be streamed and other external services, such as lightweight machine to machine (LwM2M) resources, enterprise systems and commercial management systems, which may be crawled to provide additional remote device data.

The index 13 of remote device data is searchable by a user and therefore may provide a document based search engine with indexed live remote device 22 reported data and cloud 20-1 stored data about a remote device 22. More than one index 13 may be stored at the document store 12. For example, different indexes 13 can be provided for different users, or customers, of a remote device management service, thus providing multitenancy.

The search query operates exclusively on the indexed data, thus providing sub-second speed without imposing a data bandwidth load or cost on the data sources 20 and/or the remote device 22 itself, since the search query does not result in communication with the data sources 20 or remote devices 22.

The document storage and search functions may be agnostic towards connectivity. Remote devices 22 may be connected via LwM2M, Message Queuing Telemetry Transport (MQTT), proprietary Representational State Transfer (REST) API, or anything else, such that a user can use the system to manage the state of the remote devices 22.

The apparatus 10 comprises an outbound delta processor 24 to transmit or push a desired state to a remote device 22, when the desired state does not match a last reported state of the remote device 22 defined in the structured state document 14 for that remote device 22. The outbound delta processor 24 may transmit or push a desired state to a plurality of remote devices 22.

The apparatus 10 comprises an inbound notification processor 26 to receive a current state of the remote device 22, to update the last reported state of the remote device 22 in the structured state document 14. The inbound notification processor 26 may receive a current state of a plurality of devices 22.

The apparatus 10 comprises a document processor 28 to perform calculating the difference between the desired state of the remote device 22 and the last reported state of the remote device 22 and generating or updating a device state delta document 30 defining values required to change the current state of the remote device 22 to the desired state of the remote device 22. The device state delta document 30 may be stored in the document store 20.

In order to provide user control, the apparatus 10 comprises an application programming interface 32 to receive user input 34, the user input 34 comprising a request for a change of state of one or more of the plurality of remote devices 22. The request for a change of state of one or more of the plurality of remote devices 22 is in the form of a state change request document 34. The state change request document 34 is submitted by the user for processing but may not be stored. The state change request document 34 may provide a desired state of the remote device 22. The desired state of the remote device 22 may be stored in the document store 12 along with the last reported device state for the remote device 22.

The document processor 28 performs validation of the received user input 34 by comparing the received user input 34 with allowable user input as defined by the document schema 16. If any state change request document 34 is not correctly formed according to the comparison with document schema 16, then the state change request is rejected.

In some embodiments, the structured state document 14 comprises data segmented into a plurality of user permission levels and the document processor 28 performs checking of the user input 34 to ascertain whether the user has the required user permission level access to allow the generation of the device state delta document 30. The user permission level access may be defined in metadata as part of the structured state document 14.

In examples of a segmented structured state document 14, two or more permission levels may be defined. Each of the two or more permission levels may require the user to have a corresponding permission level access in order for the user to be able to access and/or modify the data within each of the permission levels of the segmented structured state document 14.

A first permission level access may be defined which allows access to device data. The device data may include one or more of a remote device location, a current device specific operating value, a desired device specific operating value, or a device measurement value. Of course, other device data may be defined dependent on the remote device 22 to which the structured state document 14 pertains. The lowest permission level access, which may be the first permission level access, may be accessible to anyone and may not require any particular user permissions. Alternatively the lowest permission level access may still require some user permission, authorisation or authentication for a user to be able to access or request modification of the device data.

A second permission level access may be defined which allows access to critical device operation data. The critical device operating data may include one or more of firmware level, where such data may be required for firmware updates, communication setup information, a time of the last update of the remote device 22, or an error state. Of course, other critical device operation data may be defined dependent on the remote device 22 to which the structured state document 14 pertains.

In some embodiments the second permission level access above may be the highest permission level, requiring high level permissions for a user to access the data.

Further permission level access may be defined. Further permission level access may be intermediate between the lowest and the highest permission level access requiring an intermediate level of user permission. Alternatively, different users may have different permissions to access data in the segmented structured state document 14 for which they have a requirement to access.

The apparatus 10 may comprise a remote device 22 to receive a requested change of state from the outbound delta processor 24 and to transmit a current state of the remote device 22 to an inbound notification processor 26.

The apparatus 10 may form a wider system with a plurality of devices 22, each of which is communicatively coupled or coupleable to each of the outbound delta processor 24 and inbound notification processor 26. The plurality of devices 22 may be geographically disparate, and may be on different networks. The plurality of devices 22 may be communicatively coupled or coupleable via any device communication mechanism.

The operation of the apparatus 10 will now be described with reference to FIGS. 2 to 9, where FIGS. 2 to 4 relate to the apparatus 10-1 and corresponding method 100 for requesting a change of state of a remote device 22, FIGS. 5 to 7 relate to the apparatus 10-2 and corresponding method 200 for updating the state of the remote device 22 in the index 13, and FIGS. 8 and 9 relate to the apparatus 10-3 and corresponding method 300 for reading from, or querying, the index 13.

FIG. 2 illustrates a schematic diagram of an apparatus 10-1 which facilitates a user requesting a change of state of one or more remote devices 22. The apparatus 10 shown in FIG. 1 is formed, in part, by apparatus 10-1, the operation of which will now be described with reference to FIG. 3. FIG. 3 illustrates a flow diagram of blocks of a method 100 for requesting a change of state of one or more remote devices 22.

The method 100 comprises, at block 102, receiving a user input 34 in the form of a state change request document 34 at an application programming interface 32, for example via a REST API. The state change request document 34 defines a desired state of one or more of a plurality of remote devices 22. An example state change request document 34 is shown below.

{

“document_schema”: 1,
“changes”: [

{

“op”: “replace”,
“path”:
“/variables/example_device_variable/desired_value”,
“value”: “2”

}

]

}

Upon receipt of the state change request document 34, the state change request document 34 is compared, at block 104, to a document schema 16 in a document processor 28 to ensure conformity. The state change request document 34 may be a new structured state document 14. Only if there is conformity between the state change request document 34 and the document schema 16 will the document processor 28 provide for the identification of remote devices 22 which have a last reported state which is not equal to the desired state and provide for the instructions to be transmitted to the identified remote devices 22.

The method comprises, at block 106, identifying, from an index 13 of remote device data, which of the plurality of remote devices 22 has a last reported state which is not equal to the desired state.

At block 108 a device state delta document 30 is created when one or more of the plurality of remote devices 22 is identified to have a last reported state which is not equal to the desired state. An example device state delta document 30 is shown below. In this example this is the same as the state change request document 34 example above as the state change request must be pushed to the remote device 22.

{

“document_schema”: 1,
“changes”: [

{

“op”: “replace”,
“path”:
“/variables/example_device_variable/desired_value”,
“value”: “2”

}

]

}

At block 110, the device state delta document 30 is processed at an outbound delta processor 24, to form the instructions to each of the identified remote devices 22. The device state delta document 30 specifies the remote device 22 variables that should be updated, and to what values the variables should be updated to. The outbound delta processor 24 converts the requirements for remote device 22 variable changes into calls to a communication library. The communication library is responsible for executing commands to effect the remote device 22 variable changes, the commands varying depending upon the connectivity method for a particular remote device 22.

At block 112, instructions are transmitted to each of the identified remote devices 22, to change a current state of each of the identified remote devices 22 to the desired state.

At block 114, the instructions to change the current state of the remote device to the desired state are received at the remote device 22.

At block 116, the current state of the remote device 22 is changed to the desired state.

At block 118, the synchronisation between the current state of the remote device 22 and the desired state is monitored. In embodiments the synchronisation between the current state of the remote device 22 and the desired state is monitored by the outbound delta processor 24. The outbound delta processor 24 may also perform retries of the updates and handle errors in the update process. If the current state matches the desired state then the remote device 22 has been updated and the update process ends at block 120. If there is no synchronisation for the remote device 22, that is the current state does not match the desired state, then retransmission of the instructions to the remote device will be performed 122, to instigate a reattempt of the change of the current state of the remote device 22 to the desired state. In some embodiments, if the current state does not match the desired state but the state changes to something other than the desired state then this is identified by the document processor 28 and the retransmission of the instructions to the remote device 22 will cease. The outbound delta processor 24 will not transmit or push the desired state to the remote device 22 until the desired state is updated again.

FIG. 4 illustrates a sequence diagram for the editing of structured state documents in accordance with the process flow of FIG. 3 described above.

FIG. 5 illustrates a schematic diagram of an apparatus 10-2 which facilitates updating the state of the remote device 22 in the index 13. The apparatus 10 shown in FIG. 1 is formed, in part, by apparatus 10-2, the operation of which will now be described with reference to FIG. 6. FIG. 6 illustrates a flow diagram of blocks of a method 200 for updating the state of the remote device 22 in the index 13.

The method 200 comprises, at block 202, receiving, at an inbound notification processor 26, a current state of a remote device 22 from the remote device 22.

At block 204, it is determined if a structured state document 14 for the remote device 22 requires updating. The determination of whether a structured state document 14 for the remote device 22 requires updating is carried out by the inbound notification processor 26. This may be done by retrieving the current structured state document 14 from the document store 12 and checking for conformity. In particular, conformity between the structured state document 14 and the received current state of the remote device 22 is checked. That is, the various values and/or variables of the structured state document 14 for the remote device 22 are compared to the various values and/or variables in the received current state of the remote device 22. Thereby the desired state of the remote device 22 and last reported state of the remote device 22 are compared, and values and/or variables of the remote device 22 which are out of synchronisation are then required to be correspondingly updated.

At block 206, when the structured state document 14 for the remote device 22 is determined to require updating, then the update of the structured state document 14 is notified to the document processor 28 to instigate a validation process. This validation process ensures conformity with the document schema 16. To perform this function a patch may be constructed for the elements for which the structured state document 14 needs updating. A patch is a document which defines changes to some aspects of the remote device 22 which are required in the remote device 22. The patch may therefore be important for remote devices 22 which are out of synchronisation with a desired state of the remote device 22. A patch request is created and transmitted to the document processor for processing, following which the structured state document 14 may be updated. The patch may conform to a standard format, such as JSONPatch.

This may allow re-use of existing libraries, thereby simplifying processing and user understanding of the patch.

At block 208, the structured state document 14 is updated when the update of the structured state document 14 has been successfully validated at the document processor 28. The validation ensures that the applied patch is valid. If the patch is valid then the structured state document 14 is updated.

At block 210, the index 13 of remote device data is updated with the current state of the remote device 22.

Method 200 for updating the state of a remote device 22 in the index 13 may be performed simultaneously for a plurality of remove devices 22.

FIG. 7 illustrates a sequence diagram for the editing of structured state documents in accordance with the process flow of FIG. 6 described above.

It may be necessary to allow document concurrency and versioning in order to provide the ability to update the structured state document 14 while it is also being updated by another process. The other process may be from the remote device 22 itself, or in the form of a further state change request document 34 at the application programming interface 32. In order for this to be implemented, each structured state document 14 has a version number. This version number is monotonically increased each time the structured state document 14 is successfully altered.

In addition to the version number, each structured state document 14 has two timestamps showing when it was last modified, via the application programming interface 32 and the remote device 22 respectively. The document store is responsible for locking the structured state document 14 so that edits of the structured state document 14 can only be performed sequentially in order of arrival. Where necessary updates will be held in a queue and processed sequentially.

FIG. 8 illustrates a schematic diagram of an apparatus 10-3 which facilitates a user query of the index 13. The user query is intended to identify the last reported state of a remote device 22 or a plurality of remote devices 22.

The apparatus 10-3 which facilitates a user query of the index 13 is a subset of that shown in FIG. 1, as the query of the index 13, does not require any communication with the remote device 22. Instead the user communicates with the index 13, via the application programming interface 32, where the last reported state of the remote device 22 is stored. Therefore the remote device 22, the outbound delta processor 24, and inbound notification processor 26 shown in FIG. 1 are not required as part of the index query apparatus 10-3. The apparatus 10-3 comprises a document store 12 to store an index 13 of remote device data, the remote device data being aggregated in a structured state document 14, conforming to a document schema 16, from a plurality of data sources 20-1, 20-2 for each of a plurality of remote devices 22. The apparatus 10-3 also comprises an application programming interface 32 to receive user input 36, the user input 36 being a query of the index 13 of remote device data.

The apparatus 10 shown in FIG. 1 is formed, in part, by apparatus 10-3, the operation of which will now be described with reference to FIG. 9. FIG. 9 illustrates a flow diagram of blocks of a method 300 for querying the index 13.

The method 300 comprises, at block 302, receiving a user input 36 at an application programming interface 32. The user input 36 provides a query of the index 13 of remote device data. The query may comprise filters and searches on the documents.

In some embodiments, as shown in dashed line at block 304, the user input 36 may be stored. In particular in embodiments that provide for queuing of queries, the user input 36 may be stored for iterative queries of the index 13. Such iterative queries may be carried out a predetermined number of times, or for a predetermined time period, for example. In other embodiments, the user input 36 may be stored to be compared to subsequent new or updated structured state documents 14.

At block 306, when the user input 36 in the form of a query of the index 13 of remote device data has been received, data for one or more of a plurality of remote devices 22 is received in response from the index 13 of remote device data, the index 13 being an index of structured state documents 14 conforming to a document schema 16, the structured state documents 14 comprising data from a plurality of data sources 20-1, 20-2, for each of the plurality of remote devices 22.

In some embodiments with stored user input 36, data for one or more of a plurality of remote devices 22 may be received from the index 13 of remote device data when a new or updated structured state document 14 subsequently matches the stored user input 36. This is shown in dashed line at block 308.

In some embodiments the user input 36 defines a time, which may be a defined time or one or more defined time periods, and the subsequently received data excludes data which was created prior to the defined time or outside of the defined one or more time periods. Metadata from structured state documents 14 may indicate a last time of modification for various data elements, and be used to provide useful results to the search query.

The structured state document 14 may comprise data in a plurality of user permission levels, the received data being limited to that available to the user based on a permission level of the user.

In an example search, if it is required to find all remote devices 22 where the last reported value “example_resource” is between 10 and 20, a search query, such as a HTTP GET request, can be entered in the document based search engine as follows:

{

“query”: {

“type”: {

“value”: “device”

},
“range”: {

“variables.example_resource.reported_value”: {

“gte”: 10,
“lte”: 20

}

}

}

}

The search engine may then provide return values as follows:

{

“took”: 58,
“timed_out”: false,
“_shards”: {

“total”: 5,
“successful”: 5,
“failed”: 0

},
“hits”: {

“total”: 2,
“max_score”: 0.2876821,
“hits”: [

{

“_index”: “account_name_all”,
“_type”: “device”,
“_id”: “100”,
“_score”: 0.2876821,
“_source”: {

“resource”: “example_resource”,
“value”: “19”

}

},
{

“_index”: “account_name_all”,
“_type”: “device”,
“_id”: “101”,
“_score”: 0.28582606,
“_source”: {

“resource”: “example_resource”,
“value”: “11”

}

}

]

}

}

The above describes a cloud based system or reflector such that structured state documents 14 for a plurality of remote devices 22 and a searchable index 13 are always available in the cloud.

In some embodiments a templating system for the cloud based system or reflector may be provided to allow a machine-readable device configuration to be set once for a class or subset of devices and then propagated to real-world remote devices 22. The templating system may also provide a way to capture human-readable information about a class or subset of devices including errata, manuals, and specifications.

When a reflection of a remote device 22 is wished to be created or updated by a user, in particular as a structured state document 14 to be stored in the document store 12, information from multiple sources is often required. In order to achieve this a templating system may be provided where a master template is created. In order to create a mater template an initial master template outline is created. Then any source document specified in the master template is imported.

The creation of the initial master template outline and/or the importation of any source document specified in the master template may be performed offline using a local tool, or optionally implemented as part of functionality of the cloud service.

The source documents may be linked to the master template via URL and therefore can be stored anywhere. The master template may for example have one or more source template or parent, which may be, for example, a vendor template stored on an external system accessible via URL. The resultant master template may then be stored in the document store 12.

Template information may include one or more of: device configuration settings, which may be settings which are sent to the remote devices 22; cloud configuration settings, which may control how the remote device 22 is treated in the cloud; workflow and permissions configurations; installation specific data, which may include remote device 22 location and/or environment information; remote device 22 metadata, such as vendor and remote device 22 identification data; human readable hardware specifications; machine readable hardware specifications; links to external information; and human readable description of a remote device 22.

Once the master template has been created, this may then be applied to remote devices 22 to create the structured state document 14 for each remote device 22. In some embodiments this is a cloud based bulk operation which creates or updates a structured state document 14, or reflection, for each of the remote devices 22 defined by a list of devices, based on the master template.

In embodiments, modifying the mater template does not affect the remote devices 22 unless the master template is re-applied to the remote devices 22 to modify the structured state document 14 for each remote device 22.

The master templates and/or structured state documents 14 may comprise two sections to delineate information specific to a document and that information which is from an external source. By sectioning the information for the master templates and/or structured state documents 14, data which has been imported can be separately selected to be overridden as required.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In one alternative, an embodiment of the present techniques may be realized in the form of a computer implemented method of deploying a service comprising steps of deploying computer program code operable to, when deployed into a computer infrastructure or network and executed thereon, cause said computer system or network to perform steps of the method.

In a further alternative, the preferred embodiment of the present techniques may be realized in the form of a data carrier having functional data thereon, said functional data comprising functional computer data structures to, when loaded into a computer system or network and operated upon thereby, enable said computer system to perform steps of the method.

It will be clear to one skilled in the art that many improvements and modifications can be made to the foregoing exemplary embodiments without departing from the scope of the present techniques.

1. An apparatus comprising:
a document store to store an index of remote device data, the remote device data being aggregated in a structured state document, conforming to a document schema, from a plurality of data sources for each of a plurality of remote devices;
an outbound delta processor to transmit a desired state to a remote device when the desired state does not match a last reported state of the remote device defined in the structured state document for that remote device; and
an inbound notification processor to receive a current state of the remote device to update the last reported state of the remote device in the structured state document.

2. An apparatus as claimed in claim 1, comprising:
a document processor to perform calculating the difference between the desired state of the remote device and the last reported state of the remote device and generating a device state delta document defining values required to change the current state of the remote device to the desired state of the remote device.

3. An apparatus as claimed in claim 2, comprising:
an application programming interface to receive user input, the user input comprising a request for a change of state of one or more of the plurality of remote devices.

4. An apparatus as claimed in claim 3, wherein the document processor performs validation of the received user input by comparing the received user input with allowable user input as defined by the document schema.

5. An apparatus as claimed in claim 3, wherein the structured state document comprises data segmented into a plurality of user permission levels and the document processor performs checking of the user input to ascertain whether the user has the required user permission level access to allow the generation of the device state delta document.

6. An apparatus as claimed in claim 5, wherein a first permission level access allows access to device data including one or more of a device location, a current device specific operating value, a desired device specific operating value, a device measurement value.

7. An apparatus as claimed in claim 5, wherein a second permission level access allows access to critical device operation data, including one or more of firmware level, communication setup, a time of last update of device, an error state.

8. An apparatus as claimed in claim 1, comprising a remote device to receive a requested change of state from the outbound delta processor and to transmit a current state of the remote device to an inbound notification processor.

9. A method comprising:
receiving a user input at an application programming interface, the user input comprising a state change request document defining a desired state of one or more of a plurality of remote devices;
identifying, from an index of remote device data, which of the plurality of remote devices has a last reported state which is not equal to the desired state; and
transmitting instructions to each of the identified remote devices, to change a current state of each of the identified remote devices to the desired state.

10. A method according to claim 9, comprising:
comparing, upon receipt of the state change request document, the state change request document to a document schema in a document processor to ensure conformity, and only if there is conformity between the state change request document and the document schema are remote devices identified which have a last reported state which is not equal to the desired state and the instructions transmitted to the identified remote devices.

11. A method according to claim 9, comprising:
creating a device state delta document when one or more of the plurality of remote devices is identified to have a last reported state which is not equal to the desired state; and
processing, at an outbound delta processor, the device state delta document to form the instructions to each of the identified remote devices.

12. A method according to claim 9, comprising:
monitoring the synchronisation between the current state of the remote device and the desired state, and if there is no synchronisation for the remote device then performing retransmission of the instructions to the remote device, to change a current state of the remote device to the desired state.

13. A method according to claim 9, comprising:
receiving, at the remote device, the instructions to change the current state of the remote device to the desired state; and
changing the current state of the remote device to the desired state.

14. A method comprising:
receiving, at an inbound notification processor, a current state of a remote device from the remote device;
determining, at the inbound notification processor, if a structured state document for the remote device requires updating;
when the structured state document for the remote device is determined to require updating, validating the update of the structured state document at a document processor.

15. A method as claimed in claim 14, wherein determining if the structured state document for the remote device requires updating comprises retrieving the structured state document from a document store and checking for conformity between the structured state document and the received current state of the remote device.

16. A method as claimed in claim 15, wherein if it is determined that the structured state document for the remote device requires updating then a patch for identified elements of the structured state document for which the structured state document needs updating is constructed.

17. A method as claimed in claim 16, wherein the patch conforms to a standard format, such as JSONPatch.

18. A method as claimed in claim 16, comprising:
transmitting the patch to the document processor to update the identified elements of the structured state document.

19. A method as claimed in claim 16, comprising:
updating the structured state document when the update of the structured state document is validated at the document processor.

20. A method as claimed in claim 18, comprising:
updating an index of remote device data with the current state of the remote device.

21-25. (canceled)
